(19) United States
(12) Patent Application Publication
(10) Pub. No.: US 2025/0264785 A1
(43) Pub. Date: Aug. 21, 2025

(54) LIGHT-FOLDED CAMERA MODULE AND ELECTRONIC DEVICE

(71) Applicant: LARGAN DIGITAL CO., LTD., Taichung City (TW)

(72) Inventors: Lin-An CHANG, Taichung City (TW); Te-Sheng TSENG, Taichung City (TW); Wen-Hung HSU, Taichung City (TW); Ming-Ta CHOU, Taichung City (TW)

(21) Appl. No.: 19/049,057

(22) Filed: Feb. 10, 2025

Related U.S. Application Data
(60) Provisional application No. 63/555,469, filed on Feb. 20, 2024.

(51) Int. Cl. G03B 17/17; G02B 1/04; G02B 7/02; G02B 7/10; G03B 3/10; G03B 17/12; H04N 23/54; H04N 23/55; H04N 23/68

(52) U.S. Cl. CPC G03B 17/17; G02B 1/041; G02B 7/021; G02B 7/10; G03B 3/10; G03B 17/12; H04N 23/54; H04N 23/55; H04N 23/687

(57) ABSTRACT

A light-folded camera module has an incident axis and an exiting axis, and includes a fixing carrier, a reflecting element, a first lens assembly, a second lens assembly and an image sensor. The reflecting element is for folding an imaging light of the light-folded camera module from the incident axis to the exiting axis. The reflecting element includes an incident surface and an exiting surface. The second lens assembly is for providing an optical refractive power of the light-folded camera module along with the first lens assembly. The image sensor is for receiving the imaging light of the light-folded camera module. The light-folded camera module further includes a focus driving device, and a degrees of freedom and a driving force for the first lens assembly to be moved along a direction parallel to the incident axis are provided.

### RELATED APPLICATIONS

This application claims priority to U.S. Provisional Application Ser. No. 63/555,469, filed Feb. 20, 2024, which is herein incorporated by reference.

### BACKGROUND

### Technical Field

The present disclosure relates to a light-folded camera module. More particularly, the present disclosure relates to a light-folded camera module applicable to portable electronic devices.

### Description of Related Art

In recent years, portable electronic devices have developed rapidly. For example, intelligent electronic devices and tablets have been filled in the lives of modern people, and camera modules mounted on portable electronic devices have also prospered. However, as technology advances, the quality requirements of the camera module are becoming higher and higher. Therefore, a camera module, which can improve the image quality, needs to be developed.

### SUMMARY

According to one aspect of the present disclosure, a light-folded camera module has an incident axis and an exiting axis, and includes a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device, the focus driving device includes a fixed component, a movable component and a spherical element. The first lens assembly is disposed on the movable component. The spherical element is disposed between the fixed component and the movable component, so that a degrees of freedom and a driving force for the first lens assembly to be moved along a direction parallel to the incident axis are provided. When a longest driving distance range of the first lens assembly from the focus driving device is Dim, a height of the reflecting element along the direction parallel to the incident axis is H, and a distance between a center of an image-side surface of the second lens assembly and a center of the image sensor along the direction parallel to the incident axis is Lf, the following conditions are satisfied: 0.8 mm<Dim<3.9 mm; and 0≤Lf<H.

According to another aspect of the present disclosure, an electronic device includes the light-folded camera module of the aforementioned aspect.

According to another aspect of the present disclosure, a light-folded camera module has an incident axis and an exiting axis, and includes a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device, the focus driving device includes a fixed component, a movable component and a spherical element. The first lens assembly is disposed on the movable component. The spherical element is disposed between the fixed component and the movable component, so that a degrees of freedom and a driving force for the first lens assembly to be moved along a direction parallel to the incident axis are provided. When a perpendicular distance between a center of the image sensor and the incident axis is S, a height of the reflecting element along the direction parallel to the incident axis is H, and a distance between a center of an image-side surface of the second lens assembly and the center of the image sensor along the direction parallel to the incident axis is Lf, the following conditions are satisfied: 4.5 mm<S<20 mm; and 0≤Lf<H.

According to another aspect of the present disclosure, a light-folded camera module has an incident axis and an exiting axis, and includes a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device and an image stabilizing device, the focus driving device is for providing a driving force for the first lens assembly to be moved along a direction parallel to the incident axis, the image stabilizing device is for providing another driving force for the image sensor to be moved within a plane perpendicular to the exiting axis. When a height of the reflecting element along the direction parallel to the incident axis is H, and a distance between a center of an image-side surface of the second lens assembly and a center of the image sensor along the direction parallel to the incident axis is Lf, the following condition is satisfied: 0≤Lf<H.

According to another aspect of the present disclosure, an electronic device includes the light-folded camera module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of a light-folded camera module according to the 1st embodiment of the present disclosure.

FIG. 1B is an exploded view of the light-folded camera module according to the 1st embodiment of FIG. 1A.

FIG. 1C is an exploded view of the three-dimensional image stabilizing device and the image sensor of the light-folded camera module according to the 1st embodiment of FIG. 1B.

FIG. 1D is another exploded view of the light-folded camera module according to the 1st embodiment of FIG. 1A.

FIG. 1E is an exploded view of the three-dimensional image stabilizing device and the image sensor of the light-folded camera module according to the 1st embodiment of FIG. 1D.

FIG. 1F is a cross-sectional view of the light-folded camera module according to the 1st embodiment of FIG. 1A.

FIG. 1G is a schematic view of the first lens assembly of the light-folded camera module according to a 1st example of the 1st embodiment of FIG. 1F, while the first lens assembly moves along a direction parallel to the incident axis.

FIG. 1H is a schematic view of the reflecting element of the light-folded camera module according to the 1st example of the 1st embodiment of FIG. 1B.

FIG. 1I is another schematic view of the reflecting element of the light-folded camera module according to the 1st example of the 1st embodiment of FIG. 1D.

FIG. 2 is a schematic view of the first lens assembly of the light-folded camera module according to a 2nd example of the 1st embodiment of FIG. 1F, while the first lens assembly moves along a direction parallel to the incident axis.

FIG. 3 is a schematic view of the first lens assembly of the light-folded camera module according to a 3rd example of the 1st embodiment of FIG. 1F, while the first lens assembly moves along a direction parallel to the incident axis.

FIG. 4 is a schematic view of the first lens assembly of the light-folded camera module according to a 4th example of the 1st embodiment of FIG. 1F, while the first lens assembly moves along a direction parallel to the incident axis.

FIG. 5 is a schematic view of the first lens assembly of the light-folded camera module according to a 5th example of the 1st embodiment of FIG. 1F, while the first lens assembly moves along a direction parallel to the incident axis.

FIG. 6 is a schematic view of the first lens assembly of the light-folded camera module according to a 6th example of the 1st embodiment of FIG. 1F, while the first lens assembly moves along a direction parallel to the incident axis.

FIG. 7A is a three-dimensional schematic view of a light-folded camera module according to the 2nd embodiment of the present disclosure.

FIG. 7B is an exploded view of the two-dimensional image stabilizing device and the image sensor of the light-folded camera module according to the 2nd embodiment of FIG. 7A.

FIG. 7C is another exploded view of the two-dimensional image stabilizing device and the image sensor of the light-folded camera module according to the 2nd embodiment of FIG. 7A.

FIG. 7D is a schematic view of the reflecting element of the light-folded camera module according to the 2nd embodiment of FIG. 7A.

FIG. 7E is another schematic view of the reflecting element of the light-folded camera module according to the 2nd embodiment of FIG. 7A.

FIG. 8A is a schematic view of an electronic device according to the 3rd embodiment of the present disclosure.

FIG. 8B is another schematic view of the electronic device according to the 3rd embodiment of FIG. 8A.

FIG. 8C is a schematic view of an image captured via the ultra-wide-angle camera module of the electronic device according to the 3rd embodiment of FIG. 8B.

FIG. 8D is another schematic view of the image captured via the high-pixel camera module of the electronic device according to the 3rd embodiment of FIG. 8A.

FIG. 8E is the other schematic view of the image captured via the telephoto camera module of the electronic device according to the 3rd embodiment of FIG. 8B.

FIG. 9 is a schematic view of an electronic device according to the 4th embodiment of the present disclosure.

FIG. 10A is a schematic view of a light-folded camera module applied to a vehicle instrument according to the 5th embodiment of the present disclosure.

FIG. 10B is a schematic view of the light-folded camera module configured in the vehicle instrument according to the 5th embodiment in FIG. 10A.

FIG. 10C is another schematic view of the light-folded camera module configured in the vehicle instrument according to the 5th embodiment in FIG. 10A.

### DETAILED DESCRIPTION

The present disclosure provides a light-folded camera module having an incident axis and an exiting axis, and including a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device, the focus driving device includes a fixed component, a movable component and a spherical element. The first lens assembly is disposed on the movable component. The spherical element is disposed between the fixed component and the movable component, so that a degrees of freedom and a driving force for the first lens assembly to be moved along a direction parallel to the incident axis are provided. When a longest driving distance range of the first lens assembly from the focus driving device is Dim, a height of the reflecting element along the direction parallel to the incident axis is H, and a distance between a center of an image-side surface of the second lens assembly and a center of the image sensor along the direction parallel to the incident axis is Lf, the following conditions are satisfied: 0.8 mm<Dim<3.9 mm; and 0≤Lf<H. The present disclosure provides a light-folded camera module with compact size by a mechanism configuration, which can fold the entire light path more than 90 degrees, and the grouping lens assemblies can focus inside an enough space. It is favorable for reducing the bearing load of the focus driving device, providing a focus driving device consuming lower electricity, with high controlling precision, and providing a feasibility of the inner focus lens assemblies to drive in long-driving-path by fixing the reflecting element and a part of the lens assemblies, and only focusing by another part of the lens assemblies. Moreover, it is favorable for reducing the physical back focal space of the light-folded camera module of the present disclosure.

In detail, the incident surface and the exiting surface of the reflecting element can be coplanar, but the present disclosure is not limited thereto. The longest driving distance range of the first lens assembly represents a displacement between a position of the first lens assembly when the light-folded camera module focuses at infinity and a position of the first lens assembly when the light-folded camera module focuses at a minimum object-distance. The minimum object-distance of the light-folded camera module can be other values, and is depended on an optical specification design value of the light-folded camera module, but the value in the present disclosure is not limited thereto. Further, the measurement of the distance is a non-negative scalar, and the distance between two points can be zero when the measuring positions of the two points are on a same reference positon. Therefore, it is favorable for providing a sufficient space for group focusing by reducing the total height of the light-folded camera module of the present disclosure.

When the longest driving distance range of the first lens assembly from the focus driving device is Dim, the following condition is satisfied: 0.9 mm<Dim<3.2 mm. Thus, it is favorable for obtaining higher image quality at both of distance shooting and close up shooting.

Furthermore, the following condition is satisfied: 1.0 mm<Dim<2.6 mm. Therefore, it is favorable for reducing the sensitivity of the assembling tolerance, and ensuring high image quality while the light-folded camera module is focusing.

When a perpendicular distance between the center of the image sensor and the incident axis is S, the following condition is satisfied: 4.5 mm<S<20 mm. Thus, it is favorable for achieving an optical design project of the telephoto imaging system in the limited geometrical space. Moreover, the following condition is satisfied: 6.0 mm<S<17 mm. Therefore, it is favorable for preventing the image sensor from impacting with the lens assemblies and the focus driving device while assembling so as to increase the assembling efficiency.

The reflecting element is made of plastic, and has at least one gate trace. Thus, it is favorable for increasing the manufacturing precision and the mass production efficiency.

The reflecting element includes at least two reflecting surfaces. Therefore, it is favorable for providing a larger folded angle for the reflecting element.

A number of the at least two reflecting surfaces is an odd number. Thus, it is favorable for providing the reflecting element with compact size. Moreover, the reflecting surface of the reflecting element and the incident surface can be coplanar, the reflecting surface and the exiting surface can be coplanar or the reflecting surface can be an independent surface, but the present disclosure is not limited thereto.

The first lens assembly includes at least one glass lens element and at least one plastic lens element. Therefore, it is favorable for increasing the environment tolerance and providing stable optical quality.

When a distance between a center of an object-side surface of the second lens assembly and the center of the image sensor along the direction parallel to the incident axis is Ls, and a distance between the center of the object-side surface of the second lens assembly and a position where the exiting axis passes through the exiting surface of the reflecting element along the direction parallel to the incident axis is Le, the following condition is satisfied: 0≤Ls<Le. Thus, it is favorable for reducing physical space of the back focal telephoto camera module, and providing a miniaturized optical system configuration.

The light-folded camera module can further include a two-dimensional image stabilizing device. The two-dimensional image stabilizing device is for providing a driving force for the image sensor to be moved within a plane perpendicular to the exiting axis. Therefore, it is favorable for obtaining the optical image stabilization of the light-folded camera module.

The light-folded camera module can further include a three-dimensional image stabilizing device. The three-dimensional image stabilizing device is for providing a driving force for the image sensor to be moved within a three-dimensional space. Thus, it is favorable for obtaining the optical image stabilization of the light-folded camera module. In detail, the image stabilizing device can provide a preloading force and the degrees of freedom for the image sensor via a spherical element or an elastic element, but the present disclosure is not limited thereto.

The present disclosure provides a light-folded camera module having an incident axis and an exiting axis, and including a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device, the focus driving device includes a fixed component, a movable component and a spherical element. The first lens assembly is disposed on the movable component. The spherical element is disposed between the fixed component and the movable component, so that a degrees of freedom and a driving force for the first lens assembly to be moved along a direction parallel to the incident axis are provided. When a perpendicular distance between a center of the image sensor and the incident axis is S, a height of the reflecting element along the direction parallel to the incident axis is H, and a distance between a center of an image-side surface of the second lens assembly and the center of the image sensor along the direction parallel to the incident axis is Lf, the following conditions are satisfied: 4.5 mm<S<20 mm; and 0≤Lf<H.

When the perpendicular distance between the center of the image sensor and the incident axis is S, the following condition is satisfied: 6.0 mm<S<17 mm. Thus, it is favorable for preventing the image sensor from impacting with the lens assemblies and the focus driving device while assembling so as to increase the assembling efficiency.

The reflecting element includes at least two reflecting surfaces. Therefore, it is favorable for providing a larger folded angle for the reflecting element.

A number of the at least two reflecting surfaces is an odd number. Thus, it is favorable for providing the reflecting element with compact size.

The first lens assembly includes at least one glass lens element and at least one plastic lens element. Therefore, it is favorable for increasing the environment tolerance and providing stable optical quality.

The reflecting element is made of plastic, and has at least one gate trace. Thus, it is favorable for increasing the manufacturing precision and the mass production efficiency.

The light-folded camera module can further include a two-dimensional image stabilizing device. The two-dimensional image stabilizing device is for providing a driving force for the image sensor to be moved within a plane perpendicular to the exiting axis. Therefore, it is favorable for obtaining the optical image stabilization of the light-folded camera module.

The light-folded camera module can further include a three-dimensional image stabilizing device. The three-dimensional image stabilizing device is for providing a driving force for the image sensor to be moved within a three-dimensional space. Thus, it is favorable for obtaining the optical image stabilization of the light-folded camera module.

The present disclosure provides a light-folded camera module having an incident axis and an exiting axis, and including a fixing carrier, a reflecting element, a first lens assembly, a second lens assembly and an image sensor. The reflecting element is for folding an imaging light of the light-folded camera module from the incident axis to the exiting axis. The reflecting element is fixed on the fixing carrier, and the reflecting element includes an incident surface and an exiting surface. The second lens assembly is for providing an optical refractive power of the light-folded camera module along with the first lens assembly. The first lens assembly, the second lens assembly and the incident surface of the reflecting element are disposed along the incident axis sequentially. The image sensor is for receiving the imaging light of the light-folded camera module. The image sensor is disposed relative to the exiting surface of the reflecting element along the exiting axis. The second lens assembly is fixed in the fixing carrier, so that there is no relative displacement between the second lens assembly and the reflecting element. The light-folded camera module further includes a focus driving device and an image stabilizing device, the focus driving device is for providing a driving force for the first lens assembly to be moved along a direction parallel to the incident axis, the image stabilizing device is for providing another driving force for the image sensor to be moved within a plane perpendicular to the exiting axis. When a height of the reflecting element along the direction parallel to the incident axis is H, and a distance between a center of an image-side surface of the second lens assembly and a center of the image sensor along the direction parallel to the incident axis is Lf, the following condition is satisfied: 0≤Lf<H.

The reflecting element further includes at least two reflecting surfaces. Therefore, it is favorable for providing a larger folded angle for the reflecting element.

A number of the at least two reflecting surfaces is an odd number. Thus, it is favorable for providing the reflecting element with compact size.

The reflecting element is made of plastic, and has at least one gate trace. Therefore, it is favorable for increasing the manufacturing precision and the mass production efficiency.

When a distance between a center of an object-side surface of the second lens assembly and the center of the image sensor along the direction parallel to the incident axis is Ls, and a distance between the center of the object-side surface of the second lens assembly and a position where the exiting axis passes through the exiting surface of the reflecting element along the direction parallel to the incident axis is Le, the following condition is satisfied: 0≤Ls<Le. Thus, it is favorable for reducing a physical space of the back focal telephoto camera module, and providing a miniaturized optical system configuration.

Each of the aforementioned features of the imaging lens assembly can be utilized in various combinations for achieving the corresponding effects.

The present disclosure provides an electronic device. The electronic device includes the aforementioned light-folded camera module.

According to the aforementioned embodiment, specific embodiments and examples are provided, and illustrated via figures.

### 1st Embodiment

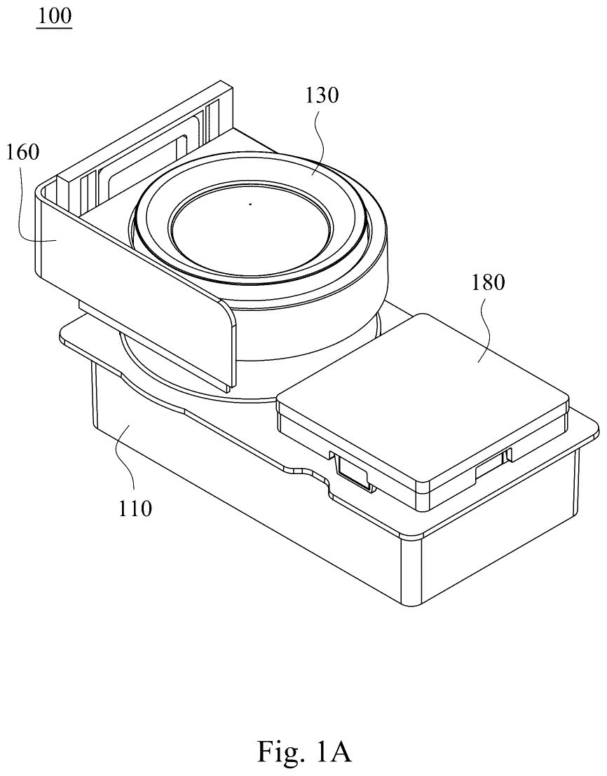

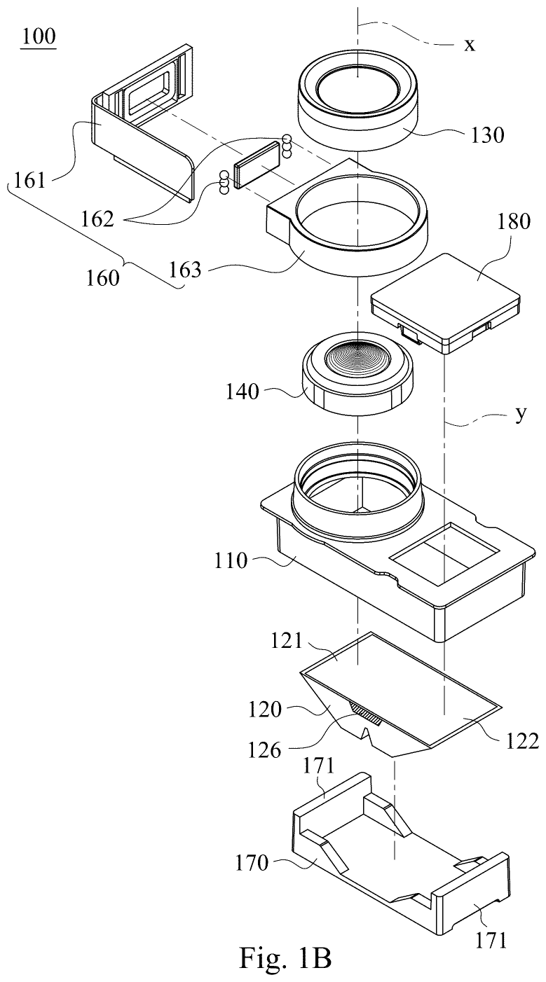

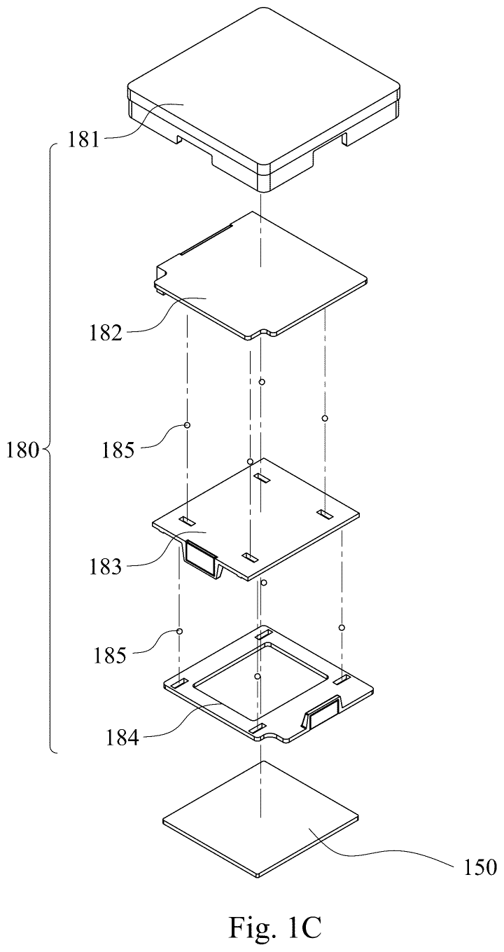

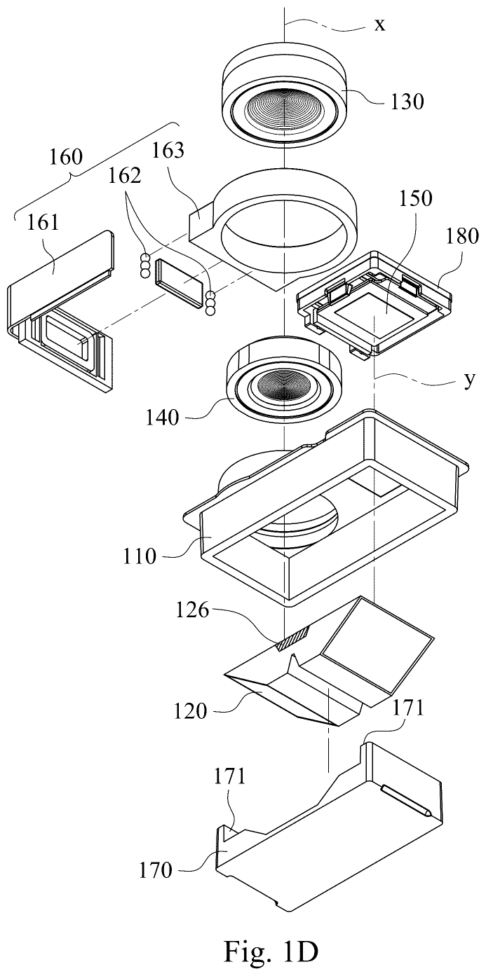

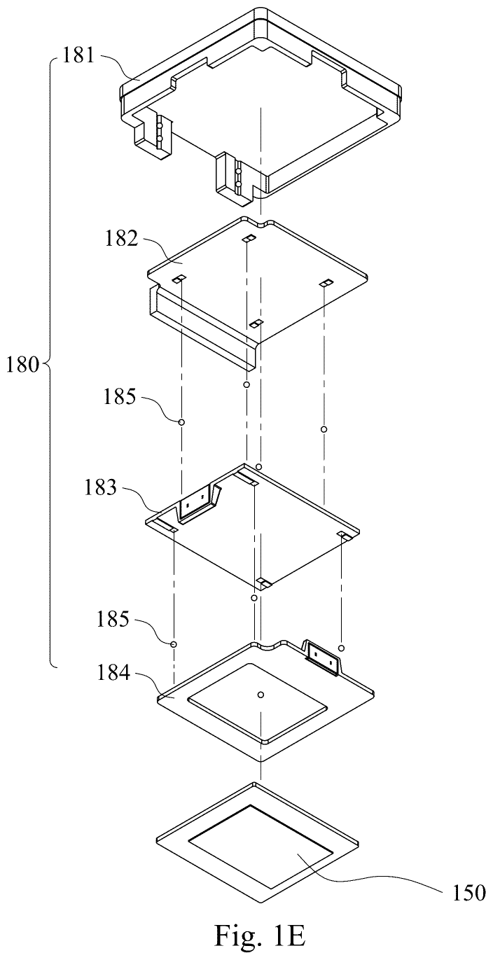

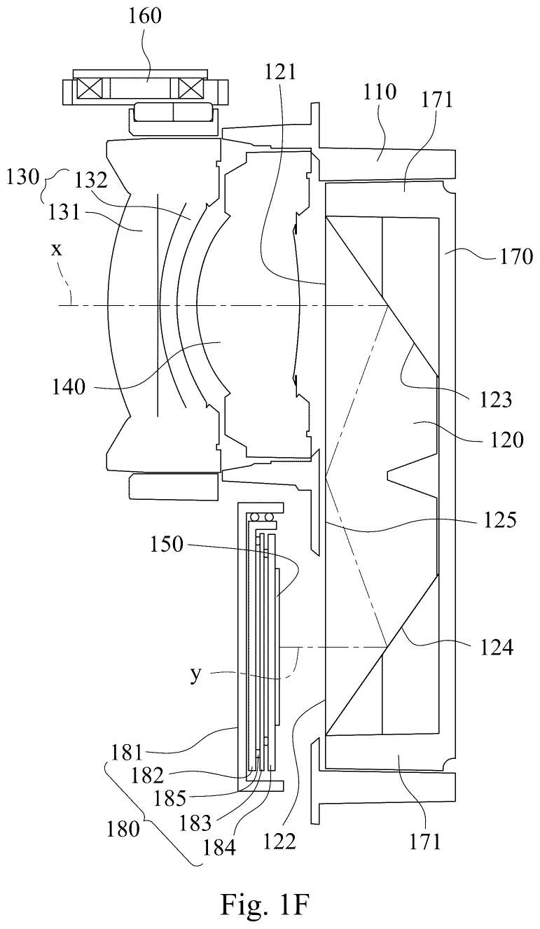

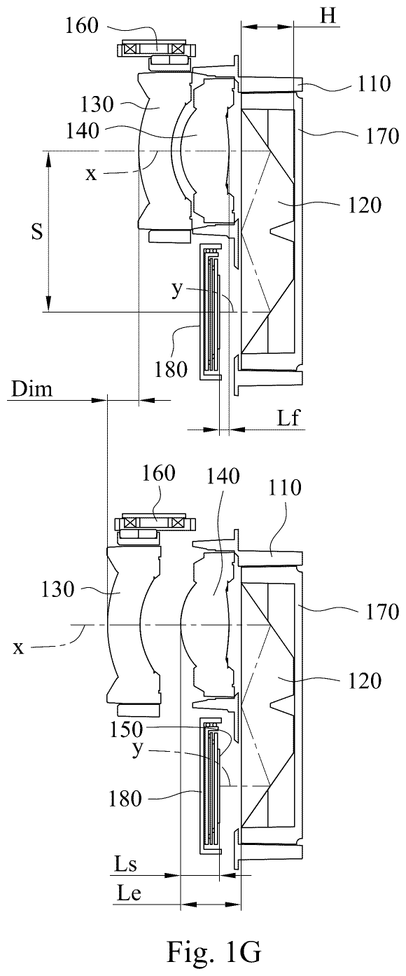

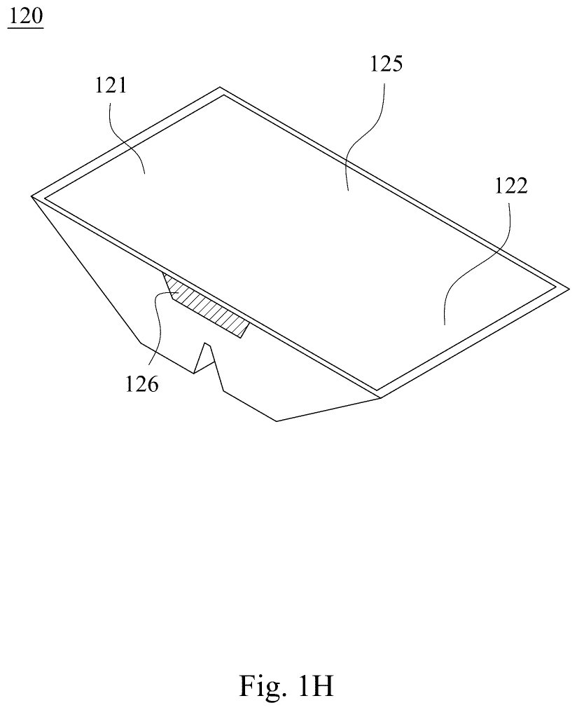

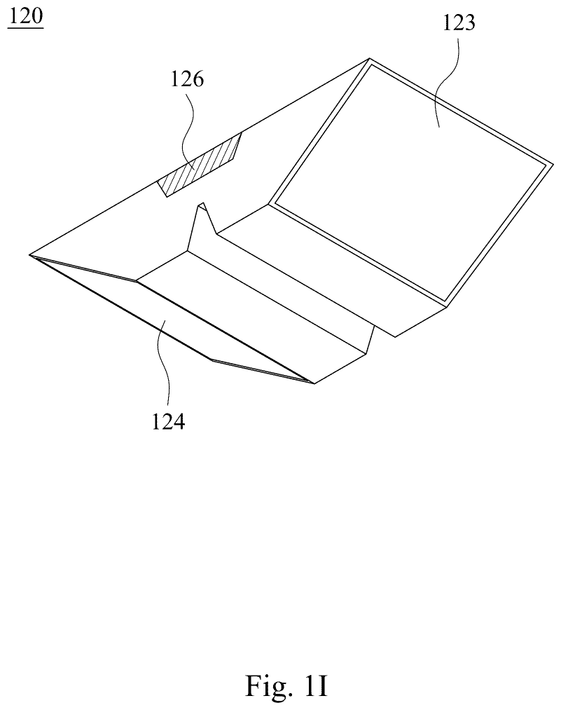

Please refer to FIG. 1A, FIG. 1B, FIG. 1C, FIG. 1D and FIG. 1E. FIG. 1A is a three-dimensional schematic view of a light-folded camera module 100 according to the 1st embodiment of the present disclosure. FIG. 1B is an exploded view of the light-folded camera module 100 according to the 1st embodiment of FIG. 1A. FIG. 1C is an exploded view of the three-dimensional image stabilizing device 180 and the image sensor 150 of the light-folded camera module 100 according to the 1st embodiment of FIG. 1B. FIG. 1D is another exploded view of the light-folded camera module 100 according to the 1st embodiment of FIG. 1A. FIG. 1E is an exploded view of the three-dimensional image stabilizing device 180 and the image sensor 150 of the light-folded camera module 100 according to the 1st embodiment of FIG. 1D. The light-folded camera module 100 has an incident axis x and an exiting axis y, and includes a fixing carrier 110, a reflecting element 120, a first lens assembly 130, a second lens assembly 140, an image sensor 150, a focus driving device 160, an assembly fixing element 170 and a three-dimensional image stabilizing device 180. The reflecting element 120 is for folding an imaging light of the light-folded camera module 100 from the incident axis x to the exiting axis y.

The reflecting element 120 is fixed on the fixing carrier 110, and the reflecting element 120 includes an incident surface 121 and an exiting surface 122. The second lens assembly 140 is for providing an optical refractive power of the light-folded camera module 100 along with the first lens assembly 130. The first lens assembly 130, the second lens assembly 140 and the incident surface 121 of the reflecting element 120 are disposed along the incident axis x sequentially. The image sensor 150 is for receiving the imaging light of the light-folded camera module 100. The image sensor 150 is disposed relative to the exiting surface 122 of the reflecting element 120 along the exiting axis y. The second lens assembly 140 is fixed in the fixing carrier 110, so that there is no relative displacement between the second lens assembly 140 and the reflecting element 120. The focus driving device 160 includes a fixed component 161, a spherical element 162 and a movable component 163. The first lens assembly 130 is disposed on the movable component 163. The spherical element 162 is disposed between the fixed component 161 and the movable component 163, so that a degrees of freedom and a driving force for the first lens assembly 130 to be moved along a direction parallel to the incident axis x are provided.

Thus, it is favorable for the grouping lens assemblies of the light-folded camera module 100 in the 1st embodiment of the present disclosure to focus inside an enough space by folding the entire light path more than 90 degrees. Moreover, it is favorable for reducing the bearing load of the focus driving device 160 and providing a focus driving device 160 consuming lower electricity, with high controlling precision, and providing a feasibility of the inner focus lens assemblies to drive in long-driving-path by fixing the reflecting element 120 and a part of the lens assemblies (i.e., the second lens assembly 140), and only focusing by another part of the lens assemblies (i.e., the first lens assembly 130).

In FIG. 1B to FIG. 1E, the three-dimensional image stabilizing device 180 is for providing a driving force for the image sensor 150 to be moved within a three-dimensional space. Specifically, the three-dimensional image stabilizing device 180 includes a base 181, a first direction guiding member 182, a second direction guiding member 183, a third direction guiding member 184 and a plurality of spherical elements 185. The first direction guiding member 182, the second direction guiding member 183 and the third direction guiding member 184 are stacked in the base 181 sequentially, and the image sensor 150 is connected to the third direction guiding member 184. The spherical elements 185 are disposed in the base 181, the first direction guiding member 182, the second direction guiding member 183 and the third direction guiding member 184, respectively, so that the image sensor 150 can be displaced within a three-dimensional space, but the present disclosure is not limited thereto. In other embodiments, the spherical elements 185 can be replaced by elastic element to provide the preloading force and the degrees of freedom for the image sensor 150, but the present disclosure is not limited thereto.

Please refer to FIG. 1F and FIG. 1G. FIG. 1F is a cross-sectional view of the light-folded camera module 100 according to the 1st embodiment of FIG. 1A. FIG. 1G is a schematic view of the first lens assembly 130 of the light-folded camera module 100 according to a 1st example of the 1st embodiment of FIG. 1F, while the first lens assembly 130 moves along a direction parallel to the incident axis x. In FIG. 1F, the first lens assembly 130 can include two lens elements 131, 132. The two lens elements 131, 132 include a glass lens element and a plastic lens element. Thus, it is favorable for increasing the environment tolerance and providing stable optical quality. Moreover, the assembly fixing element 170 positions the reflecting element 120 in the fixing carrier 110 along a direction toward to the fixing carrier 110, and two sidewalls 171 of the assembly fixing element 170 are located between the fixing carrier 110 and the reflecting element 120. Therefore, it is favorable for increasing the assembling stability.

An upper part of FIG. 1G shows a positional relationship between the first lens assembly 130 and the focus driving device 160 when the light-folded camera module 100 focuses at infinity. A lower part of FIG. 1G shows a positional relationship between the first lens assembly 130 and the focus driving device 160 when the light-folded camera module 100 focuses at a minimum object-distance. A longest driving distance range of the first lens assembly 130 from the focus driving device 160 is Dim. A height of the reflecting element 120 along the direction parallel to the incident axis x is H. A distance between a center of an image-side surface of the second lens assembly 140 and a center of the image sensor 150 along the direction parallel to the incident axis x is Lf.

The longest driving distance range Dim of the first lens assembly 130 represents a displacement between a position of the first lens assembly 130 when the light-folded camera module 100 focuses at infinity and a position of the first lens assembly 130 when the light-folded camera module 100 focuses at a minimum object-distance. The minimum object-distance of the light-folded camera module 100 can be other values, and is depended on an optical specification design value of the light-folded camera module 100, and the value in the present disclosure is not limited thereto. Further, the measurement of the distance is a non-negative scalar, and the distance between two points can be zero when the measuring positions of the two points are on a same reference positon.

A distance between the first lens assembly 130 and the second lens assembly 140 when the light-folded camera module 100 focuses at infinity is shorter than a distance between the first lens assembly 130 and the second lens assembly 140 when the light-folded camera module 100 focuses at the minimum object-distance. Therefore, it is favorable for providing a sufficient space for group focusing by reducing the total height of the light-folded camera module 100 of the present disclosure.

A perpendicular distance between a center of the image sensor 150 and the incident axis x is S. Thus, it is favorable for achieving an optical design project of the telephoto imaging system in the limited geometrical space.

A distance between a center of an object-side surface of the second lens assembly 140 and a center of the image sensor 150 along the direction parallel to the incident axis x is Ls. A distance between a center of an object-side surface of the second lens assembly 140 and a position where the exiting axis x passes through the exiting surface 122 of the reflecting element 120 along the direction parallel to the incident axis x is Le. Therefore, it is favorable for reducing the physical space of the back focal telephoto light-folded camera module 100, and providing a miniaturized optical system configuration.

In FIG. 1G, in the 1st example of the 1st embodiment, when the height of the reflecting element 120 along the direction parallel to the incident axis x is H, the longest driving distance range of the first lens assembly 130 from the focus driving device 160 is Dim, the distance between the center of the image-side surface of the second lens assembly 140 and the center of the image sensor 150 along the direction parallel to the incident axis x is Lf, the distance between the center of the object-side surface of the second lens assembly 140 and the position where the exiting axis x passes through the exiting surface 122 of the reflecting element 120 along the direction parallel to the incident axis x is Le, the distance between the center of the object-side surface of the second lens assembly 140 and the center of the image sensor 150 along the direction parallel to the incident axis x is Ls, and the perpendicular distance between the center of the image sensor 150 and the incident axis x is S, the values thereof are listed in Table 1 as follow.

TABLE 1
1st example of the 1st embodiment

| | | | | | |
|---|---|---|---|---|---|
| H | (mm) | 2.7 | Dim | (mm) | 1.61 |
| Lf | (mm) | 0.492 | Le | (mm) | 3.12 |
| Ls | (mm) | 2 | S | (mm) | 8.291 |

Please refer to FIG. 1H and FIG. 1I. FIG. 1H is a schematic view of the reflecting element 120 of the light-folded camera module 100 according to the 1st example of the 1st embodiment of FIG. 1B. FIG. 1I is another schematic view of the reflecting element 120 of the light-folded camera module 100 according to the 1st example of the 1st embodiment of FIG. 1D. In detail, the incident surface 121 and the exiting surface 122 of the reflecting element 120 can be coplanar, but the present disclosure is not limited thereto. The reflecting element 120 is made of plastic, and has at least one gate trace 126. Further, the reflecting element 120 includes a plurality of reflecting surfaces 123, 124, 125, the imaging light is folded by the reflecting surfaces 123, 125, 124 in sequence, and reaches to the image sensor 150. A number of the reflecting surfaces 123, 124, 125 is an odd number. Furthermore, the reflecting surface 125 of the reflecting element 120 and the incident surface 121 can be coplanar, the reflecting surface 125 and the exiting surface 122 can be coplanar or the reflecting surface 125 can be an independent surface, but the present disclosure is not limited thereto.

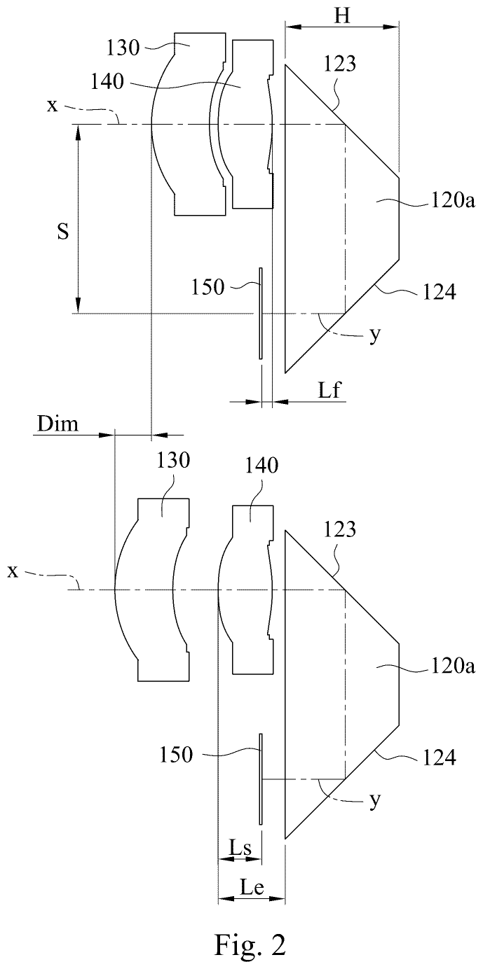

Please refer to FIG. 2. FIG. 2 is a schematic view of the first lens assembly 130 of the light-folded camera module 100 according to a 2nd example of the 1st embodiment of FIG. 1F, while the first lens assembly 130 moves along a direction parallel to the incident axis x. In FIG. 2, the difference between the 2nd example of the 1st embodiment and the 1st example of the 1st embodiment of the present disclosure is the shape of the reflecting element 120 in the 1st example and the shape of the reflecting element 120a in the 2nd example, other structures and features can be the same or similar to the 1st example, and will not be described again. Specifically, the reflecting element 120a includes two reflecting surfaces 123, 124. The imaging light is folded by the reflecting surfaces 123, 124 in order, and reaches to the image sensor 150.

An upper part of FIG. 2 shows a positional relationship between the first lens assembly 130 and the second lens assembly 140 when the light-folded camera module 100 focuses at infinity. A lower part of FIG. 2 shows a positional relationship between the first lens assembly 130 and the second lens assembly 140 when the light-folded camera module 100 focuses at a minimum object-distance. In FIG. 2, in the 2nd example of the 1st embodiment, a height of the reflecting element 120a along the direction parallel to the incident axis x is H, a longest driving distance range of the first lens assembly 130 from the focus driving device 160 is Dim, a distance between a center of an image-side surface of the second lens assembly 140 and a center of the image sensor 150 along the direction parallel to the incident axis x is Lf, a distance between a center of an object-side surface of the second lens assembly 140 and a position where the exiting axis x passes through the exiting surface 122 of the reflecting element 120a along the direction parallel to the incident axis x is Le, a distance between the center of the object-side surface of the second lens assembly 140 and the center of the image sensor 150 along the direction parallel to the incident axis x is Ls, a perpendicular distance between the center of the image sensor 150 and the incident axis x is S, the values thereof are listed in Table 2 as follow.

TABLE 2
2nd example of the 1st embodiment

| | | | | | |
|---|---|---|---|---|---|
| H | (mm) | 4.753 | Dim | (mm) | 1.53 |
| Lf | (mm) | 0.433 | Le | (mm) | 2.8 |
| Ls | (mm) | 1.825 | S | (mm) | 8.291 |

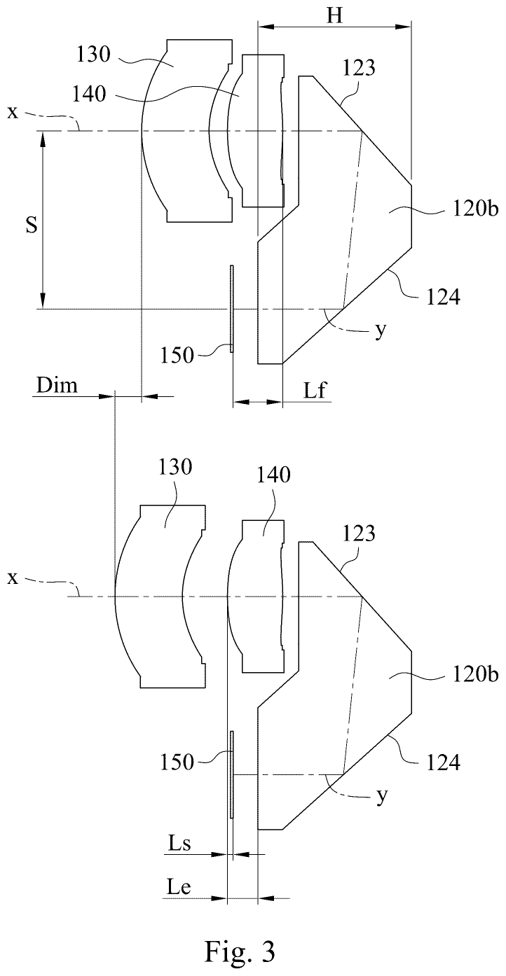

Please refer to FIG. 3. FIG. 3 is a schematic view of the first lens assembly 130 of the light-folded camera module 100 according to a 3rd example of the 1st embodiment of FIG. 1F, while the first lens assembly 130 moves along a direction parallel to the incident axis x. In FIG. 3, the difference between the 3rd example of the 1st embodiment and the 1st example of the 1st embodiment of the present disclosure is the shape of the reflecting element 120 in the 1st example and the shape of the reflecting element 120b in the 3rd example, other structures and features can be the same or similar to the 1st example, and will not be described again. Specifically, the reflecting element 120b includes two reflecting surfaces 123, 124. The imaging light is folded by the reflecting surfaces 123, 124 in order, and reaches to the image sensor 150.

An upper part of FIG. 3 shows a positional relationship between the first lens assembly 130 and the second lens assembly 140 when the light-folded camera module 100 focuses at infinity. A lower part of FIG. 3 shows a positional relationship between the first lens assembly 130 and the second lens assembly 140 when the light-folded camera module 100 focuses at a minimum object-distance. In FIG. 3, in the 3rd example of the 1st embodiment, a height of the reflecting element 120b along the direction parallel to the incident axis x is H, a longest driving distance range of the first lens assembly 130 from the focus driving device 160 is Dim, a distance between a center of an image-side surface of the second lens assembly 140 and a center of the image sensor 150 along the direction parallel to the incident axis x is Lf, a distance between a center of an object-side surface of the second lens assembly 140 and a position where the exiting axis x passes through the exiting surface 122 of the reflecting element 120b along the direction parallel to the incident axis x is Le, a distance between the center of the object-side surface of the second lens assembly 140 and the center of the image sensor 150 along the direction parallel to the incident axis x is Ls, a perpendicular distance between the center of the image sensor 150 and the incident axis x is S, the values thereof are listed in Table 3 as follow.

TABLE 3
3rd example of the 1st embodiment

| | | | | | |
|---|---|---|---|---|---|
| H | (mm) | 6.093 | Dim | (mm) | 1.05 |
| Lf | (mm) | 1.955 | Le | (mm) | 0.199 |
| Ls | (mm) | 0.224 | S | (mm) | 7.009 |

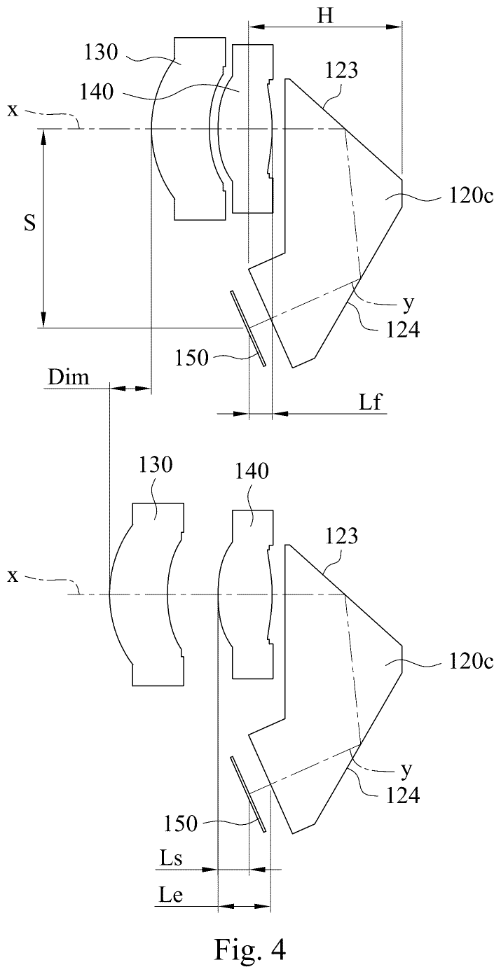

Please refer to FIG. 4. FIG. 4 is a schematic view of the first lens assembly 130 of the light-folded camera module 100 according to a 4th example of the 1st embodiment of FIG. 1F, while the first lens assembly 130 moves along a direction parallel to the incident axis x. In FIG. 4, the difference between the 4th example of the 1st embodiment and the 1st example of the 1st embodiment of the present disclosure is the shape of the reflecting element 120 in the 1st example and the shape of the reflecting element 120c in the 4th example, other structures and features can be the same or similar to the 1st example, and will not be described again. Specifically, the reflecting element 120c includes two reflecting surfaces 123, 124. The imaging light is folded by the reflecting surfaces 123, 124 in order, and reaches to the image sensor 150.

An upper part of FIG. 4 shows a positional relationship between the first lens assembly 130 and the second lens assembly 140 when the light-folded camera module 100 focuses at infinity. A lower part of FIG. 4 shows a positional relationship between the first lens assembly 130 and the second lens assembly 140 when the light-folded camera module 100 focuses at a minimum object-distance. In FIG. 4, in the 4th example of the 1st embodiment, a height of the reflecting element 120c along the direction parallel to the incident axis x is H, a longest driving distance range of the first lens assembly 130 from the focus driving device 160 is Dim, a distance between a center of an image-side surface of the second lens assembly 140 and a center of the image sensor 150 along the direction parallel to the incident axis x is Lf, a distance between a center of an object-side surface of the second lens assembly 140 and a position where the exiting axis x passes through the exiting surface 122 of the reflecting element 120c along the direction parallel to the incident axis x is Le, a distance between the center of the object-side surface of the second lens assembly 140 and the center of the image sensor 150 along the direction parallel to the incident axis x is Ls, a perpendicular distance between the center of the image sensor 150 and the incident axis x is S, the values thereof are listed in Table 4 as follow.

TABLE 4
4th example of the 1st embodiment

| | | | | | |
|---|---|---|---|---|---|
| H | (mm) | 6.412 | Dim | (mm) | 1.75 |
| Lf | (mm) | 0.955 | Le | (mm) | 2.194 |
| Ls | (mm) | 1.303 | S | (mm) | 8.33 |

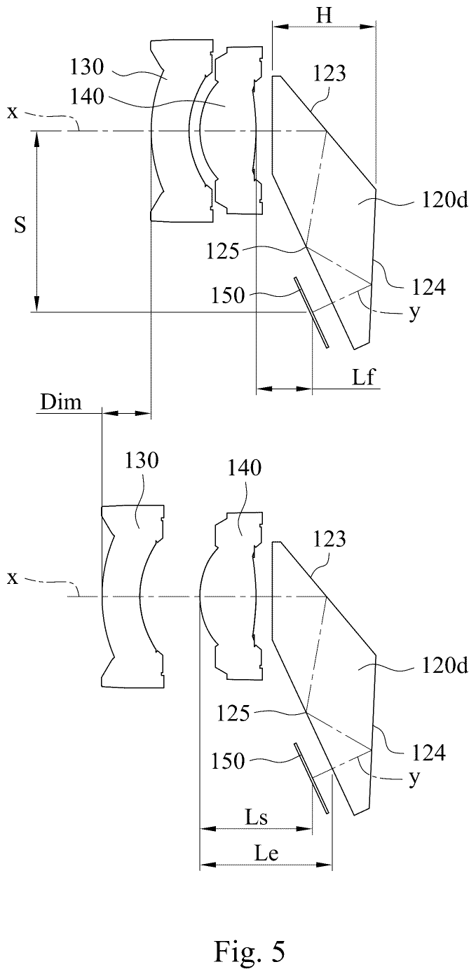

Please refer to FIG. 5. FIG. 5 is a schematic view of the first lens assembly 130 of the light-folded camera module 100 according to a 5th example of the 1st embodiment of FIG. 1F, while the first lens assembly 130 moves along a direction parallel to the incident axis x. In FIG. 5, the difference between the 5th example of the 1st embodiment and the 1st example of the 1st embodiment of the present disclosure is the shape of the reflecting element 120 in the 1st example and the shape of the reflecting element 120d in the 5th example, other structures and features can be the same or similar to the 1st example, and will not be described again. Specifically, the reflecting element 120d includes three reflecting surfaces 123, 124, 125. The imaging light is folded by the reflecting surfaces 123, 125, 124 in order, and reaches to the image sensor 150.

An upper part of FIG. 5 shows a positional relationship between the first lens assembly 130 and the second lens assembly 140 when the light-folded camera module 100 focuses at infinity. A lower part of FIG. 5 shows a positional relationship between the first lens assembly 130 and the second lens assembly 140 when the light-folded camera module 100 focuses at a minimum object-distance. In FIG. 5, in the 5th example of the 1st embodiment, a height of the reflecting element 120d along the direction parallel to the incident axis x is H, a longest driving distance range of the first lens assembly 130 from the focus driving device 160 is Dim, a distance between a center of an image-side surface of the second lens assembly 140 and a center of the image sensor 150 along the direction parallel to the incident axis x is Lf, a distance between a center of an object-side surface of the second lens assembly 140 and a position where the exiting axis x passes through the exiting surface 122 of the reflecting element 120d along the direction parallel to the incident axis x is Le, a distance between the center of the object-side surface of the second lens assembly 140 and the center of the image sensor 150 along the direction parallel to the incident axis x is Ls, a perpendicular distance between the center of the image sensor 150 and the incident axis x is S, the values thereof are listed in Table 5 as follow.

TABLE 5
5th example of the 1st embodiment

| | | | | | |
|---|---|---|---|---|---|
| H | (mm) | 4.593 | Dim | (mm) | 2.18 |
| Lf | (mm) | 2.498 | Le | (mm) | 5.874 |
| Ls | (mm) | 4.99 | S | (mm) | 8.047 |

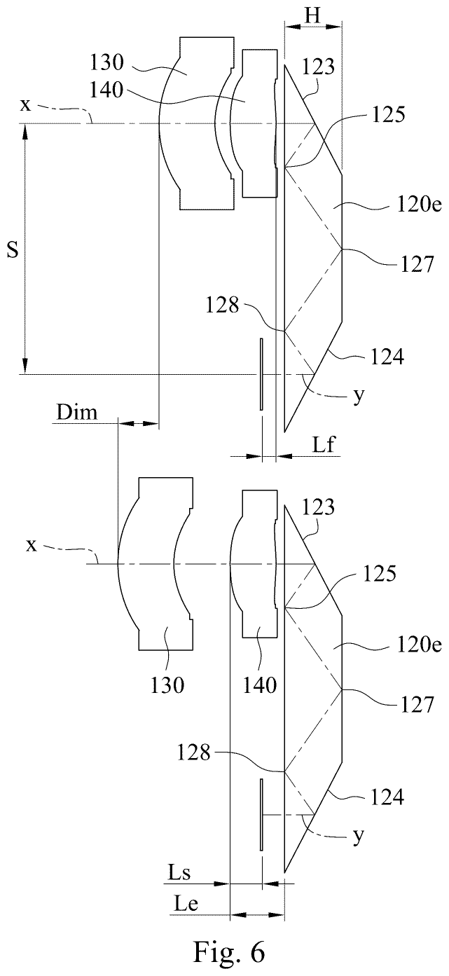

Please refer to FIG. 6. FIG. 6 is a schematic view of the first lens assembly 130 of the light-folded camera module 100 according to a 6th example of the 1st embodiment of FIG. 1F, while the first lens assembly 130 moves along a direction parallel to the incident axis x. In FIG. 6, the difference between the 6th example of the 1st embodiment and the 1st example of the 1st embodiment of the present disclosure is the shape of the reflecting element 120 in the 1st example and the shape of the reflecting element 120e in the 6th example, other structures and features can be the same or similar to the 1st example, and will not be described again. Specifically, the reflecting element 120e includes five reflecting surfaces 123, 124, 125, 127, 128. The imaging light is folded by the reflecting surfaces 123, 125, 127, 128, 124 in order, and reaches to the image sensor 150.

An upper part of FIG. 6 shows a positional relationship between the first lens assembly 130 and the second lens assembly 140 when the light-folded camera module 100 focuses at infinity. A lower part of FIG. 6 shows a positional relationship between the first lens assembly 130 and the second lens assembly 140 when the light-folded camera module 100 focuses at a minimum object-distance. In FIG. 6, in the 5th example of the 1st embodiment, a height of the reflecting element 120e along the direction parallel to the incident axis x is H, a longest driving distance range of the first lens assembly 130 from the focus driving device 160 is Dim, a distance between a center of an image-side surface of the second lens assembly 140 and a center of the image sensor 150 along the direction parallel to the incident axis x is Lf, a distance between a center of an object-side surface of the second lens assembly 140 and a position where the exiting axis x passes through the exiting surface 122 of the reflecting element 120e along the direction parallel to the incident axis x is Le, a distance between the center of the object-side surface of the second lens assembly 140 and the center of the image sensor 150 along the direction parallel to the incident axis x is Ls, a perpendicular distance between the center of the image sensor 150 and the incident axis x is S, the values thereof are listed in Table 6 as follow.

TABLE 6
6th example of the 1st embodiment

| | | | | | |
|---|---|---|---|---|---|
| H | (mm) | 2.724 | Dim | (mm) | 1.95 |
| Lf | (mm) | 0.648 | Le | (mm) | 2.582 |
| Ls | (mm) | 1.531 | S | (mm) | 11.894 |

### 2nd Embodiment

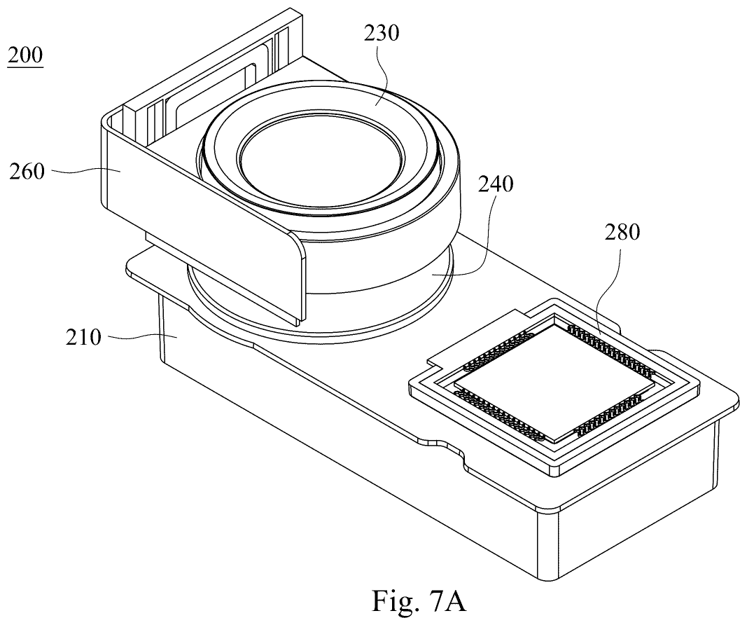

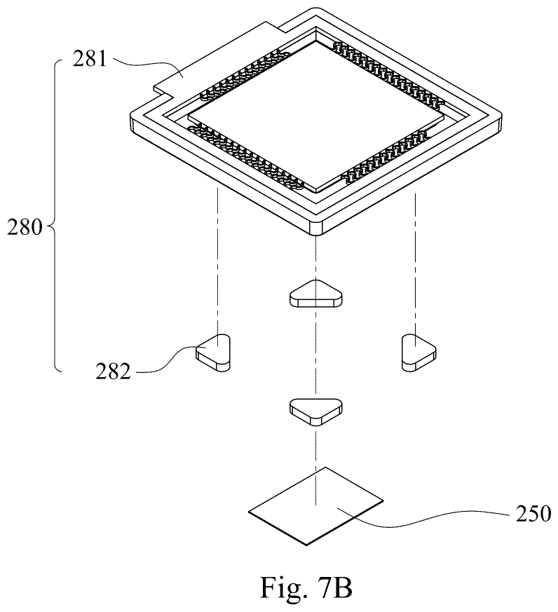

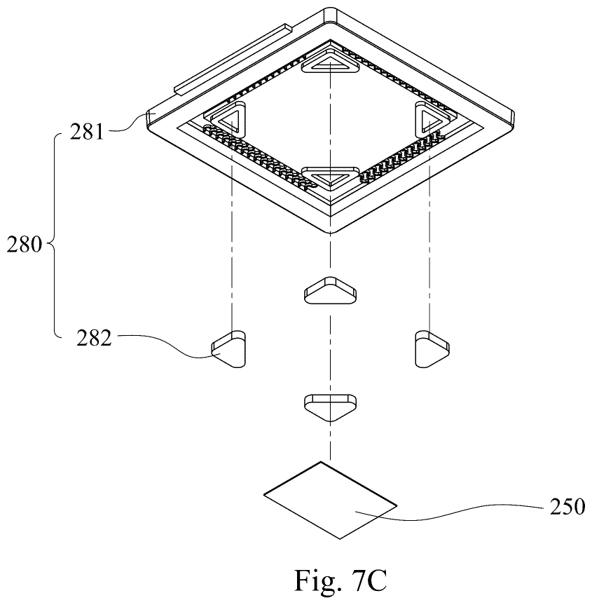

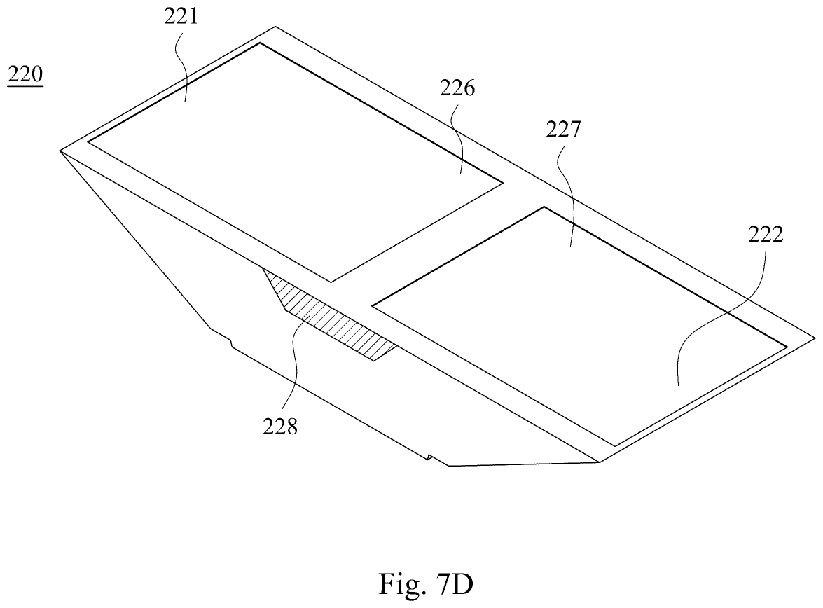

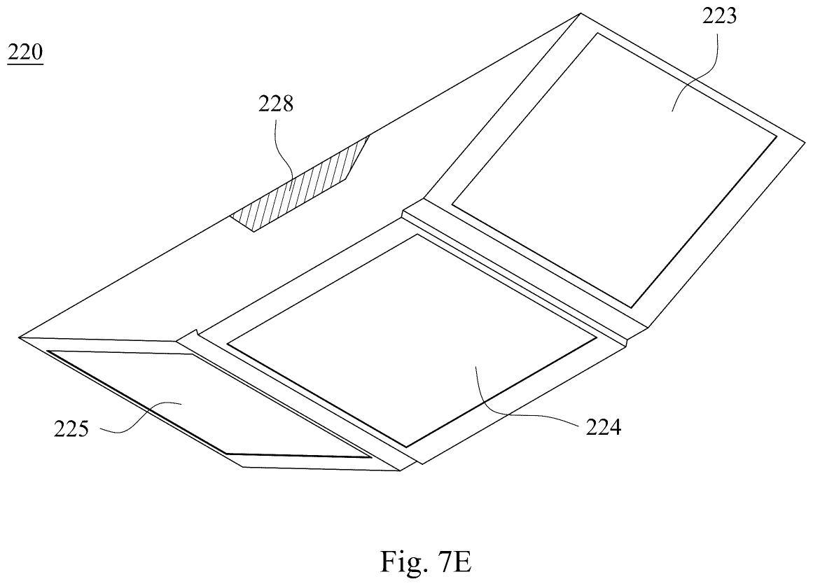

Please refer to FIG. 7A to FIG. 7E. FIG. 7A is a three-dimensional schematic view of a light-folded camera module 200 according to the 2nd embodiment of the present disclosure. FIG. 7B is an exploded view of the two-dimensional image stabilizing device 280 and the image sensor 250 of the light-folded camera module 200 according to the 2nd embodiment of FIG. 7A. FIG. 7C is another exploded view of the two-dimensional image stabilizing device 280 and the image sensor 250 of the light-folded camera module 200 according to the 2nd embodiment of FIG. 7A. FIG. 7D is a schematic view of the reflecting element 220 of the light-folded camera module 200 according to the 2nd embodiment of FIG. 7A. FIG. 7E is another schematic view of the reflecting element 220 of the light-folded camera module 200 according to the 2nd embodiment of FIG. 7A. The light-folded camera module 200 has an incident axis and an exiting axis, and includes a fixing carrier 210, a reflecting element 220, a first lens assembly 230, a second lens assembly 240, an image sensor 250, a focus driving device 260 and a two-dimensional image stabilizing device 280. The reflecting element 220 is for folding an imaging light of the light-folded camera module 200 from the incident axis to the exiting axis.

The reflecting element 220 is fixed on the fixing carrier 210, and the reflecting element 220 includes an incident surface 221 and an exiting surface 222. The second lens assembly 240 is for providing an optical refractive power of the light-folded camera module 200 along with the first lens assembly 230. The first lens assembly 230, the second lens assembly 240 and the incident surface 221 of the reflecting element 220 are disposed along the incident axis sequentially. The image sensor 250 is for receiving the imaging light of the light-folded camera module 200. The image sensor 250 is disposed relative to the exiting surface 222 of the reflecting element 220 along the exiting axis. The second lens assembly 240 is fixed in the fixing carrier 210, so that there is no relative displacement between the second lens assembly 240 and the reflecting element 220. The focus driving device 260 includes a fixed component, a movable component and a spherical element. The first lens assembly 230 is disposed on the movable component. The spherical element is disposed between the fixed component and the movable component, so that a degrees of freedom and a driving force for the first lens assembly 230 to be moved along a direction parallel to the incident axis are provided.

In FIG. 7B and FIG. 7C, the two-dimensional image stabilizing device 280 includes a base 281 and a guiding member 282. The guiding member 282 is disposed in the base 281, so that the image sensor 250 can be displaced within the two-dimensional space, but the present disclosure is not limited thereto. The two-dimensional image stabilizing device 280 is for providing a driving force for the image sensor 250 to be moved within a plane perpendicular to the exiting axis. Thus, it is favorable for obtaining the optical image stabilization of the light-folded camera module 200.

In FIG. 7D and FIG. 7E, the incident surface 221 and the exiting surface 222 of the reflecting element 220 can be coplanar, the reflecting element 220 is made of plastic, and has a gate trace 228, but the present disclosure is not limited thereto. Further, the reflecting element 220 includes a plurality of reflecting surfaces 223, 224, 225, 226, 227.

### 3rd Embodiment

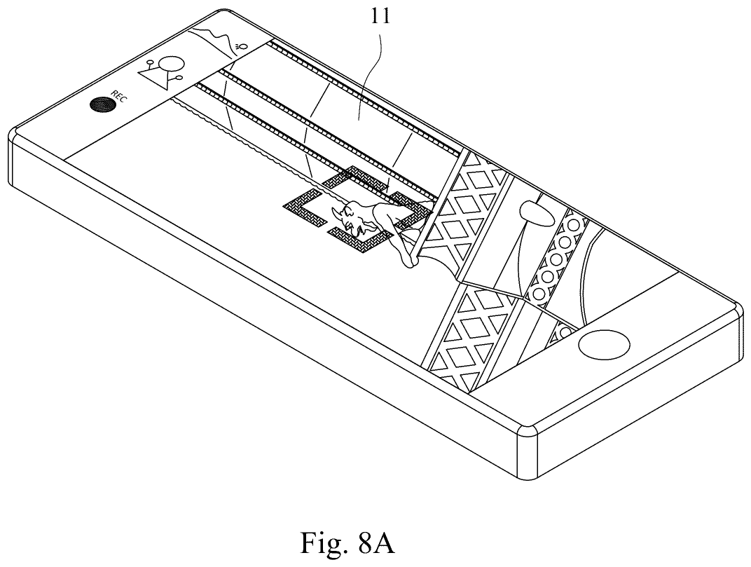

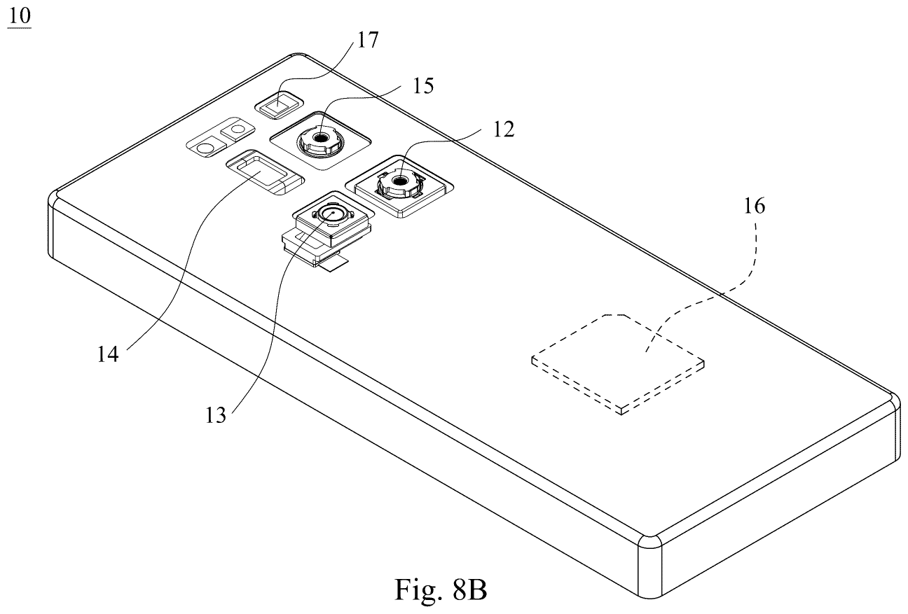

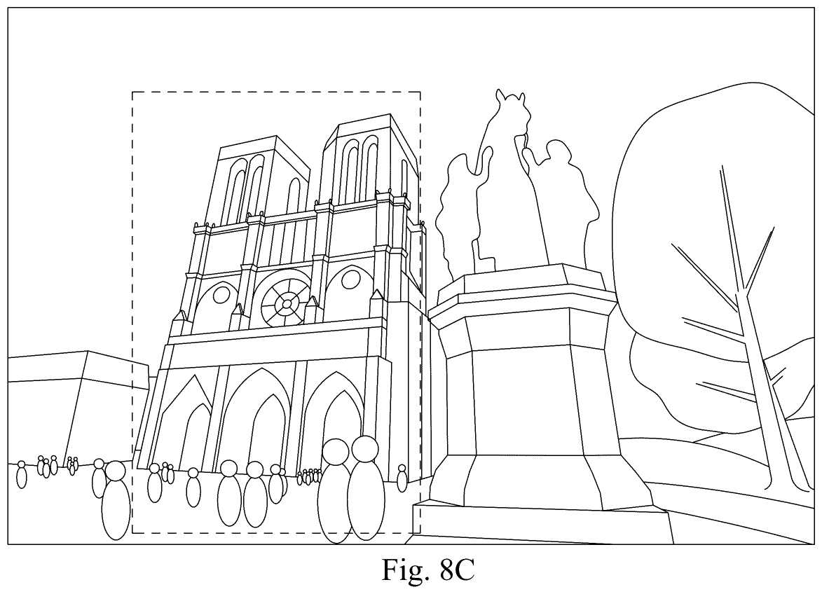

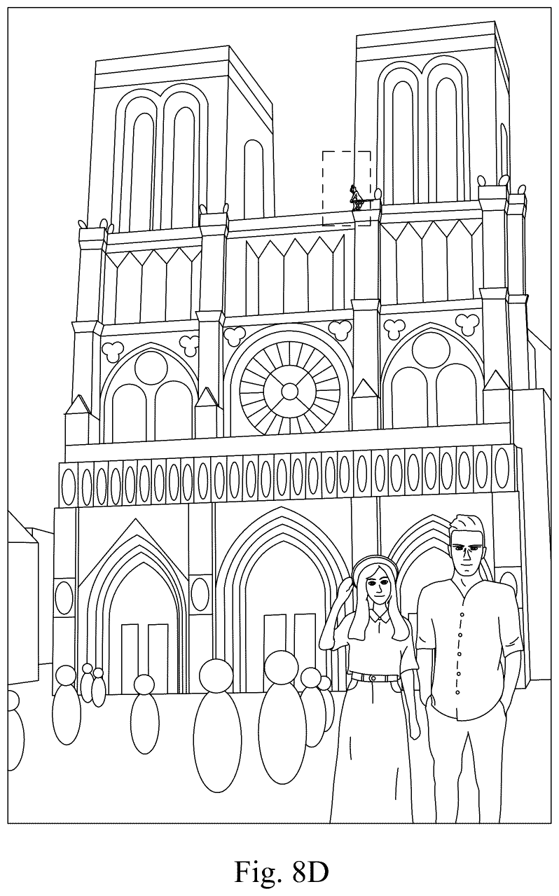

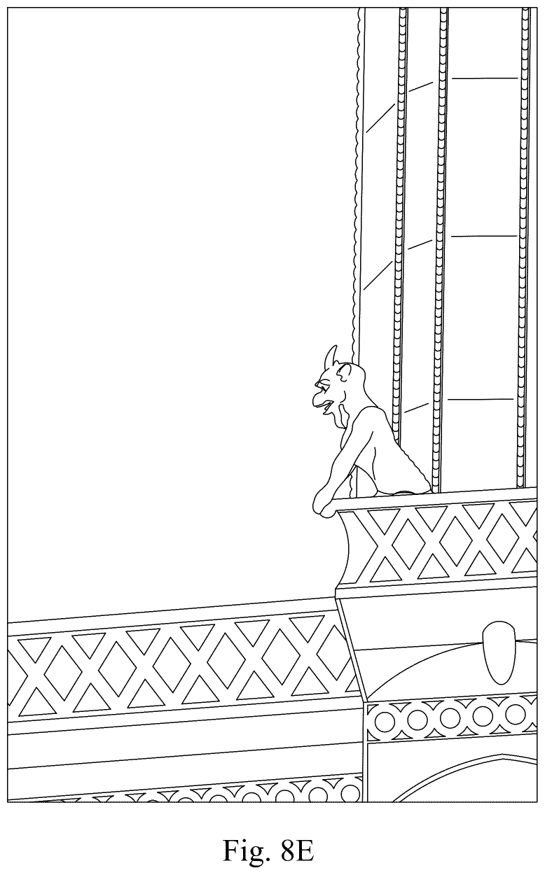

FIG. 8A is a schematic view of an electronic device 10 according to the 3rd embodiment of the present disclosure. FIG. 8B is another schematic view of the electronic device 10 according to the 3rd embodiment of FIG. 8A. As shown in FIG. 8A and FIG. 8B, the electronic device 10 is a smartphone. The electronic device 10 includes a plurality of camera modules and a user interface 11. Further, the camera modules are an ultra-wide-angle camera module 12, telephoto camera modules 13, 14 and a high-pixel camera module 15, and the user interface 11 is a touch screen, but the present disclosure is not limited thereto. Specifically, each of the camera modules can be any one of the light-folded camera module of the 1st embodiment to the 2nd embodiment, but the present disclosure will not be limited thereto.

A user enters a shooting mode via the user interface 11. The user interface 11 is used to display the screen, and the shooting angle can be manually adjusted to switch between different camera modules. At this moment, the camera modules collect an imaging light on the respective image sensor and output electronic signals associated with images to an image signal processor (ISP) 16.

As shown in FIG. 8B, according to the camera specifications of the electronic device 10, the electronic device 10 can further include an optical anti-shake mechanism (figure is omitted). Further, the electronic device 10 can further include at least one focusing assisting module (figure is omitted) and at least one sensing component (figure is omitted). The focusing assisting module can be a flash module 17, an infrared distance measurement component, a laser focus module, etc. The flash module 17 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 10 can function to obtain a great image quality and facilitate the electronic device 10 according to the present disclosure to have a capturing function with multiple modes, such as taking optimized selfies, high dynamic range (HDR) with a low light source, 4K resolution recording, etc. Furthermore, the user can visually see the captured image of the camera through the user interface 11 and manually operate the view finding range on the user interface 11 to achieve the auto focus function of what you see is what you get.

Furthermore, the camera modules, the optical anti-shake mechanism, the sensing component and the focusing assisting module can be disposed on a flexible printed circuit board (FPC) (figure is omitted) and electrically connected to the image signal processor 16 and so on via a connector (figure is omitted) so as to operate a picturing process. Recent electronic devices such as smartphones have a trend towards thinness and lightness. The imaging lens assembly and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for an autofocus function of the camera modules obtaining a flexible control via a touch screen of the electronic device. In the 3rd embodiment, the electronic device 10 can include a plurality of the sensing components and a plurality of the focusing assisting modules, and the sensing components and the focusing assisting modules are disposed on an FPC and another at least one FPC (figure is omitted) and electrically connected to the image signal processor 16 and so on via a corresponding connector so as to operate a picturing process. In other embodiments (figure is omitted), the sensing components and auxiliary optical elements can be disposed on a main board of an electronic device or a board of the other form according to a mechanical design and a requirement of a circuit layout.

Furthermore, the electronic device 10 can further include, but not be limited to, a display, a control unit, a storage unit, a random-access memory (RAM), a read-only memory (ROM), or the combination thereof.

FIG. 8C is a schematic view of an image captured via the ultra-wide-angle camera module 12 of the electronic device 10 according to the 3rd embodiment of FIG. 8B. As shown in FIG. 8C, a larger ranged image can be captured via the ultra-wide-angle camera module 12, which has a function for containing more views.

FIG. 8D is another schematic view of the image captured via the high-pixel camera module 15 of the electronic device 10 according to the 3rd embodiment of FIG. 8A. As shown in FIG. 8D, a certain ranged and high-pixel image can be captured via the high-pixel camera module 15, which has a function for high resolution and low distortion.

FIG. 8E is the other schematic view of the image captured via the telephoto camera module 13 of the electronic device 10 according to the 3rd embodiment of FIG. 8B. As shown in FIG. 8E, a far image can be captured and enlarged to a high magnification via the telephoto camera module 13, which has a function for a high magnification.

As shown in FIG. 8C to FIG. 8E, when an image is captured via different camera modules having various focal lengths and processed via a technology of an image processing, a zoom function of the electronic device 10 can be achieved.

### 4th Embodiment

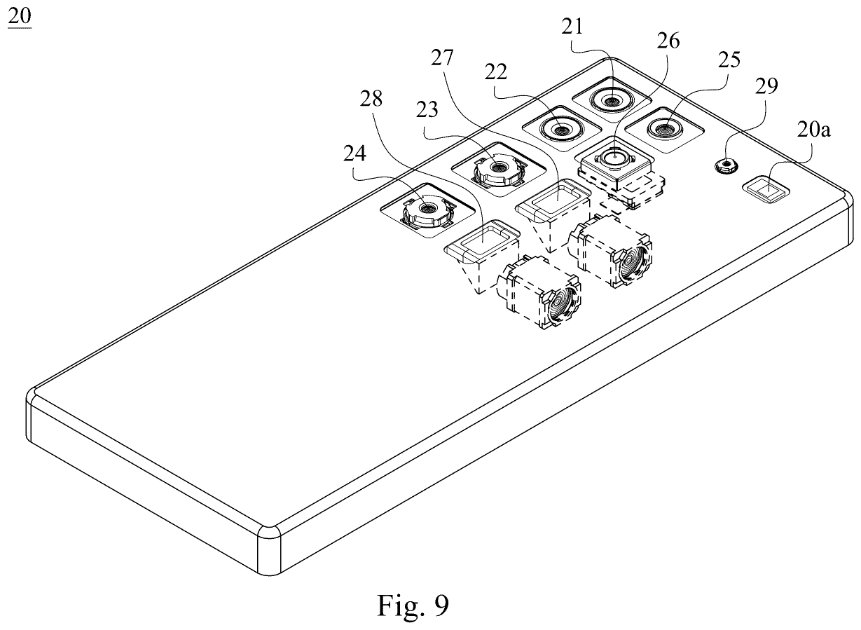

FIG. 9 is a schematic view of an electronic device 20 according to the 4th embodiment of the present disclosure. As shown in FIG. 9, the electronic device 20 is a smartphone. The electronic device 20 includes a plurality of camera modules. Further, the camera modules are two ultra-wide-angle camera modules 21, 22, two wide angle camera modules 23, 24, four telephoto camera modules 25, 26, 27, 28 and a Time-Of-Flight (TOF) module 29, wherein the Time-Of-Flight (TOF) module 29 can be other types of camera module, which will not be limited to the present arrangement. Specifically, each of the camera modules can be any one camera module of the 1st embodiment to the 3rd embodiment, but the present disclosure will not be limited thereto.

Moreover, the telephoto camera modules 27, 28 are configured to fold the light, but the present disclosure will not be limited thereto.

According to the camera specifications of the electronic device 20, the electronic device 20 can further include an optical anti-shake mechanism (figure is omitted). Further, the electronic device 20 can further include at least one focusing assisting module (figure is omitted) and at least one sensing component (figure is omitted). The focusing assisting module can be a flash module 20a, an infrared distance measurement component, a laser focus module, etc. The flash module 20a is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera module disposed on the electronic device 20 can function to obtain a great image quality and facilitate the electronic device 20 according to the present disclosure to have a capturing function with multiple modes, such as taking optimized selfies, high dynamic range (HDR) with a low light source, 4K resolution recording, etc.

Further, all of other structures and dispositions according to the 4th embodiment are the same as the structures and the dispositions according to the 3rd embodiment, and will not be described again herein.

### 5th Embodiment

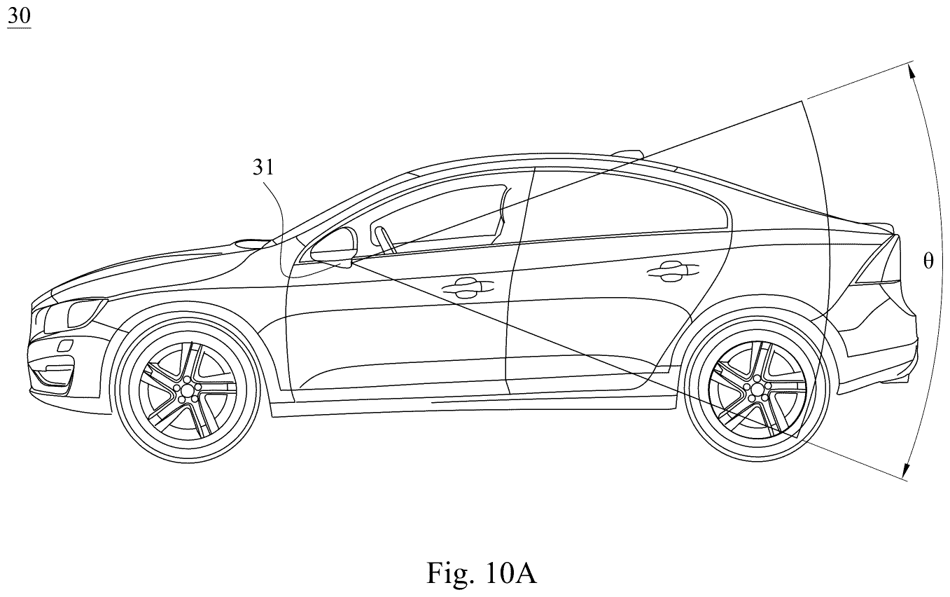

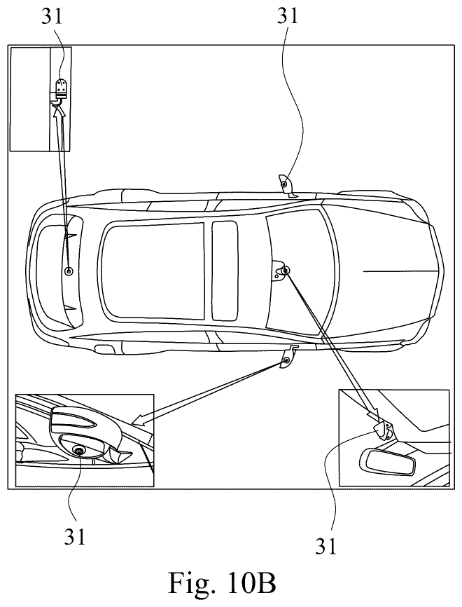

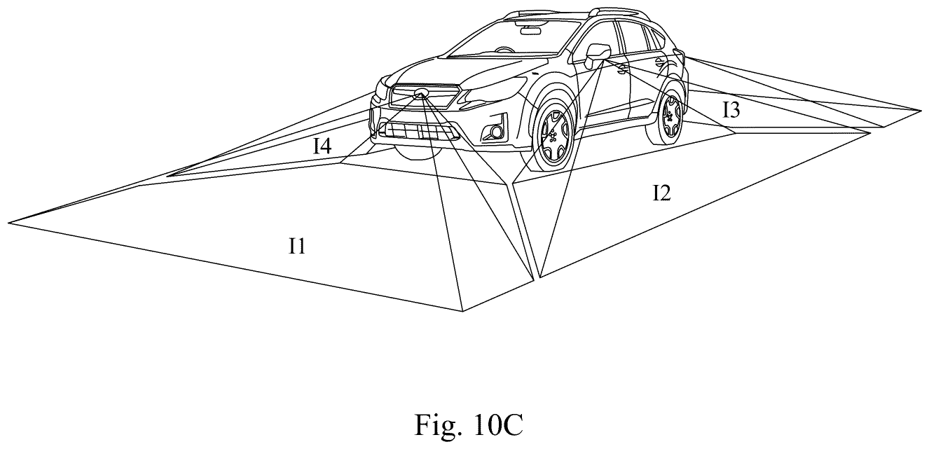

FIG. 10A is a schematic view of a light-folded camera module 31 applied to a vehicle instrument 30 according to the 5th embodiment of the present disclosure. FIG. 10B is a schematic view of the light-folded camera module 31 configured in the vehicle instrument 30 according to the 5th embodiment in FIG. 10A. FIG. 10C is another schematic view of the light-folded camera module 31 configured in the vehicle instrument 30 according to the 5th embodiment in FIG. 10A. In FIGS. 10A to 10C, the vehicle instrument 30 includes a plurality of light-folded camera modules 31. According to the 5th embodiment, a number of the light-folded camera modules 31 is six, and the light-folded camera modules 31 can be the light-folded camera module according to any one of the aforementioned 1st embodiment to 4th embodiment, but the present disclosure is not limited thereto.

In FIGS. 10A and 10B, the light-folded camera modules 31 are automotive camera modules, two of the light-folded camera modules 31 are located under rearview mirrors on a left side and a right side, respectively, and the aforementioned light-folded camera modules 31 are configured to capture the image information of a visual angle θ. In particular, the visual angle θ can satisfy the following condition: 40 degrees<θ<90 degrees. Therefore, the image information in the regions of two lanes on the left side and the right side can be captured.

In FIG. 10B, another two of the light-folded camera modules 31 can be disposed in the inner space of the vehicle instrument 30. In particular, the aforementioned two light-folded camera modules 31 are disposed on a location close to the rearview mirror inside the vehicle instrument 30 and a location close to the rear car window, respectively. Moreover, the light-folded camera modules 31 can be further disposed on the rearview mirrors of the vehicle instrument 30 on the left side and the right side except the mirror surface, respectively, but the present disclosure is not limited thereto.

In FIG. 10C, another two of the light-folded camera modules 31 can be disposed on a front end of the vehicle instrument 30 and a rear end of the vehicle instrument 30, respectively. By disposing the light-folded camera modules 31 on the front end and the rear end of the vehicle instrument 30 and under the rearview mirror on the left side of the vehicle instrument 30 and the right side of the vehicle instrument 30, it is favorable for the drivers obtaining the external space information in addition to the driving seat, such as the external space information I1, I2, I3, I4, but the present disclosure is not limited thereto. Therefore, more visual angles can be provided to reduce the blind spot, so that the driving safety can be improved. Further, the traffic information outside of the vehicle instrument 30 can be recognized by disposing the light-folded camera modules 31 on the periphery of the vehicle instrument 30, so that the function of the automatic driving assistance can be achieved.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. A light-folded camera module, having an incident axis and an exiting axis, and comprising:
a fixing carrier;
a reflecting element for folding an imaging light of the light-folded camera module from the incident axis to the exiting axis, wherein the reflecting element is fixed on the fixing carrier, and the reflecting element comprises an incident surface and an exiting surface;
a first lens assembly;
a second lens assembly for providing an optical refractive power of the light-folded camera module along with the first lens assembly, wherein the first lens assembly, the second lens assembly and the incident surface of the reflecting element are disposed along the incident axis sequentially; and
an image sensor for receiving the imaging light of the light-folded camera module, wherein the image sensor is disposed relative to the exiting surface of the reflecting element along the exiting axis;
wherein the second lens assembly is fixed in the fixing carrier, so that there is no relative displacement between the second lens assembly and the reflecting element, the light-folded camera module further comprises a focus driving device, the focus driving device comprises a fixed component, a movable component and a spherical element, the first lens assembly is disposed on the movable component, the spherical element is disposed between the fixed component and the movable component, so that a degrees of freedom and a driving force for the first lens assembly to be moved along a direction parallel to the incident axis are provided;
wherein a longest driving distance range of the first lens assembly from the focus driving device is Dim, a height of the reflecting element along the direction parallel to the incident axis is H, a distance between a center of an image-side surface of the second lens assembly and a center of the image sensor along the direction parallel to the incident axis is Lf, and the following conditions are satisfied:
$$0.8 mm < Dim < 3.9 mm ; and$$
$$0 \leq Lf < H .$$

2. The light-folded camera module of claim 1, wherein the longest driving distance range of the first lens assembly from the focus driving device is Dim, and the following condition is satisfied:
$$0.9 mm < Dim < 3.2 mm .$$

3. The light-folded camera module of claim 2, wherein the longest driving distance range of the first lens assembly from the focus driving device is Dim, and the following condition is satisfied:
$$1. mm < Dim < 2.6 mm .$$

4. The light-folded camera module of claim 1, wherein a perpendicular distance between the center of the image sensor and the incident axis is S, and the following condition is satisfied:
$$4.5 mm < S < 20 mm .$$

5. The light-folded camera module of claim 4, wherein the perpendicular distance between the center of the image sensor and the incident axis is S, and the following condition is satisfied:
$$6. mm < S < 17 mm .$$

6. The light-folded camera module of claim 1, wherein the reflecting element is made of plastic, and has at least one gate trace.

7. The light-folded camera module of claim 1, wherein the reflecting element further comprises at least two reflecting surfaces.

8. The light-folded camera module of claim 7, wherein a number of the at least two reflecting surfaces is an odd number.

9. The light-folded camera module of claim 1, wherein the first lens assembly comprises at least one glass lens element and at least one plastic lens element.

10. The light-folded camera module of claim 1, wherein a distance between a center of an object-side surface of the second lens assembly and the center of the image sensor along the direction parallel to the incident axis is Ls, a distance between the center of the object-side surface of the second lens assembly and a position where the exiting axis passes through the exiting surface of the reflecting element along the direction parallel to the incident axis is Le, and the following condition is satisfied:
$$0 \leq Ls < Le .$$

11. The light-folded camera module of claim 1, further comprising:
a two-dimensional image stabilizing device for providing a driving force for the image sensor to be moved within a plane perpendicular to the exiting axis.

12. The light-folded camera module of claim 1, further comprising:
a three-dimensional image stabilizing device for providing a driving force for the image sensor to be moved within a three-dimensional space.

13. An electronic device, comprising:
the light-folded camera module of claim 1.

14. A light-folded camera module, having an incident axis and an exiting axis, and comprising:
a fixing carrier;
a reflecting element for folding an imaging light of the light-folded camera module from the incident axis to the exiting axis, wherein the reflecting element is fixed on the fixing carrier, and the reflecting element comprises an incident surface and an exiting surface;
a first lens assembly;
a second lens assembly for providing an optical refractive power of the light-folded camera module along with the first lens assembly, wherein the first lens assembly, the second lens assembly and the incident surface of the reflecting element are disposed along the incident axis sequentially; and
an image sensor for receiving the imaging light of the light-folded camera module, wherein the image sensor is disposed relative to the exiting surface of the reflecting element along the exiting axis;
wherein the second lens assembly is fixed in the fixing carrier, so that there is no relative displacement between the second lens assembly and the reflecting element, the light-folded camera module further comprises a focus driving device, the focus driving device comprises a fixed component, a movable component and a spherical element, the first lens assembly is disposed on the movable component, the spherical element is disposed between the fixed component and the movable component, so that a degrees of freedom and a driving force for the first lens assembly to be moved along a direction parallel to the incident axis are provided;
wherein a perpendicular distance between a center of the image sensor and the incident axis is S, a height of the reflecting element along the direction parallel to the incident axis is H, a distance between a center of an image-side surface of the second lens assembly and the center of the image sensor along the direction parallel to the incident axis is Lf, and the following conditions are satisfied:
$$4.5 mm < S < 20 mm ; and$$
$$0 \leq Lf < H .$$

15. The light-folded camera module of claim 14, wherein the perpendicular distance between the center of the image sensor and the incident axis is S, and the following condition is satisfied:
$$6. mm < S < 17 mm .$$

16. The light-folded camera module of claim 14, wherein the reflecting element further comprises at least two reflecting surfaces.

17. The light-folded camera module of claim 16, wherein a number of the at least two reflecting surfaces is an odd number.

18. The light-folded camera module of claim 14, wherein the first lens assembly comprises at least one glass lens element and at least one plastic lens element.

19. The light-folded camera module of claim 14, wherein the reflecting element is made of plastic, and has at least one gate trace.

20. The light-folded camera module of claim 14, further comprising:
a two-dimensional image stabilizing device for providing a driving force for the image sensor to be moved within a plane perpendicular to the exiting axis.

21. The light-folded camera module of claim 14, further comprising:
a three-dimensional image stabilizing device for providing a driving force for the image sensor to be moved within a three-dimensional space.

22. A light-folded camera module, having an incident axis and an exiting axis, and comprising:
a fixing carrier;
a reflecting element for folding an imaging light of the light-folded camera module from the incident axis to the exiting axis, wherein the reflecting element is fixed on the fixing carrier, and the reflecting element comprises an incident surface and an exiting surface;
a first lens assembly;
a second lens assembly for providing an optical refractive power of the light-folded camera module along with the first lens assembly, wherein the first lens assembly, the second lens assembly and the incident surface of the reflecting element are disposed along the incident axis sequentially; and
an image sensor for receiving the imaging light of the light-folded camera module, wherein the image sensor is disposed relative to the exiting surface of the reflecting element along the exiting axis;
wherein the second lens assembly is fixed in the fixing carrier, so that there is no relative displacement between the second lens assembly and the reflecting element, the light-folded camera module further comprises a focus driving device and an image stabilizing device, the focus driving device is for providing a driving force for the first lens assembly to be moved along a direction parallel to the incident axis, the image stabilizing device is for providing another driving force for the image sensor to be moved within a plane perpendicular to the exiting axis;
wherein a height of the reflecting element along the direction parallel to the incident axis is H, a distance between a center of an image-side surface of the second lens assembly and a center of the image sensor along the direction parallel to the incident axis is Lf, and the following condition is satisfied:
$$0 \leq Lf < H .$$

23. The light-folded camera module of claim 22, wherein the reflecting element further comprises at least two reflecting surfaces.

24. The light-folded camera module of claim 23, wherein a number of the at least two reflecting surfaces is an odd number.

25. The light-folded camera module of claim 22, wherein the reflecting element is made of plastic, and has at least one gate trace.

26. The light-folded camera module of claim 22, wherein a distance between a center of an object-side surface of the second lens assembly and the center of the image sensor along the direction parallel to the incident axis is Ls, a distance between the center of the object-side surface of the second lens assembly and a position where the exiting axis passes through the exiting surface of the reflecting element along the direction parallel to the incident axis is Le, and the following condition is satisfied:
$$0 \leq Ls < Le .$$

27. An electronic device, comprising:
the light-folded camera module of claim 22.
